(19) United States
(12) Patent Application Publication
(10) Pub. No.: US 2022/0289222 A1
(43) Pub. Date: Sep. 15, 2022

(54) METHOD FOR EVALUATING A DECELERATION LAW, AND ASSISTED DRIVING METHOD

(71) Applicant: VALEO SYSTEMES DE CONTROLE MOTEUR, Cergy Pontoise (FR)

(72) Inventors: Florent DAVID, Cergy Pontoise (FR); Robin VINCENT, Cergy Pontoise (FR)

(73) Assignee: VALEO SYSTEMES DE CONTROLE MOTEUR, Cergy Pontoise (FR)

(21) Appl. No.: 17/623,033

(22) PCT Filed: Jun. 29, 2020
(86) PCT No.: PCT/EP2020/068234

§ 371 Date: Dec. 27, 2021

(30) Foreign Application Priority Data
Jun. 28, 2019 (FR) FR1907163

(51) Int. Cl. B60W 50/14; G01C 21/34

(52) U.S. Cl. CPC B60W 50/14; G01C 21/3469; B60W 2520/10; B60W 2510/1005; B60W 2510/0208; B60W 2540/10; B60W 2540/12; B60W 2552/15; B60W 2530/10; B60W 2530/209; B60W 2510/0638; B60W 2555/40

(57) ABSTRACT

A method for evaluating the deceleration law of a vehicle including an accelerator pedal, a brake pedal, and a powertrain including an engine, a gearbox and a unit for disconnecting the engine and gearbox, the deceleration law being defined for a discrete state of the powertrain. The method includes a first step of evaluating driving parameters, including measuring the speed (v) of the vehicle, evaluating the engaged gearbox ratio, evaluating the state of closure of the disconnecting unit, detecting the position of the accelerator pedal, detecting the position of the brake pedal, evaluating the slope (a) of the road on which the vehicle is traveling, evaluating the mass (m) of the vehicle. If the accelerator pedal is in a released position and if the brake pedal is in a released position, a second step including recording the speed (v) of the vehicle and the slope (a) of the road. A third step of computing a first coefficient (f0′), a second coefficient (f1′) and a third coefficient (f2′) of the deceleration law representing the forces F(v) being exerted on the vehicle, with the exception of the gravitational forces being exerted on the vehicle, according to the equation:

F(v)=f0′+f1′*v+f2′*v².

The invention relates to a method for evaluating a deceleration law of a vehicle, and to a method for assisting with driving using such a method for evaluating the deceleration law of a vehicle.

Driver assistance devices that analyze accelerations, decelerations and braking so as to encourage the driver to, for example, accelerate less or brake less, are known. However, these devices give driving advice only a posteriori, i.e. they give no advice on actions to be taken by the driver to reduce his consumption on his current route.

To evaluate the behavior of the vehicle on a route, the vehicle's road load is used.

The road load represents all the forces acting on the motor vehicle. It is known practice to determine the road load of a motor vehicle by recording the speed profile of the vehicle decelerating from a sufficient speed, 130 km/h for example. To determine road load, the gearbox is placed in neutral position, the accelerator control is not actuated and the brake control is also not actuated. Road load is determined on a flat road with zero slope.

The speed profile thus obtained is fitted with a polynomial of order 2:

F(v)=f0+f1*v+f2*v²

where:
F(v) is all the external forces being exerted on the vehicle plus the friction of the parts driven by the wheels, from the wheels to the gearbox,
f0, f1, f2 are the factors of the polynomial,
v is the speed of the vehicle.

Such a road load is difficult to determine because experimental conditions are difficult to meet on an open road. In addition, it varies with changes in actual driving conditions. Specifically, the mass of the vehicle may change, for example depending on the number of passengers in the vehicle. Other conditions may also change such as tire wear or tire inflation pressure.

The present invention seeks to overcome all or some of these drawbacks.

The invention relates to a method for evaluating the deceleration law of a vehicle comprising an accelerator pedal, a brake pedal, and a powertrain comprising an engine, a gearbox and a unit for disconnecting the engine and gearbox, the deceleration law being defined for a discrete state of the powertrain, the method for evaluating the deceleration law comprising:
a first step of evaluating driving parameters, comprising:
   measuring the speed of the vehicle,
   evaluating the engaged gearbox ratio,
   evaluating the state of closure of the disconnecting unit,
   detecting the position of the accelerator pedal,
   detecting the position of the brake pedal,
   evaluating the slope of the road on which the vehicle is traveling,
   evaluating the mass of the vehicle,
if the accelerator pedal is in a released position and if the brake pedal is in a released position, a second step comprising recording the speed of the vehicle and the slope of the road,
a third step of computing a first coefficient, a second coefficient and a third coefficient of the deceleration law representing the forces F(v) being exerted on the vehicle, with the exception of the gravitational forces being exerted on the vehicle, according to the equation:

F(v)=f0′+f1′*v+f2′*v²,

the first coefficient f0′, the second coefficient f1′ and the third coefficient f2′ depending on the mass m and being computed on the basis of the recording of the speed v and of the slope a via a second-order polynomial reduction, according to the equation:

d(v)/dt=f0′(m)+f1′(m)*v+f2′(m)*v²+sin(a)

the method being implemented by a computer system.

The method allows a deceleration law representative of actual driving conditions to be determined. Such a deceleration law in particular allows various elements that may affect the deceleration of the vehicle to be taken into account. For example, tire wear, vehicle load, and/or the presence of an element affecting the aerodynamics of the vehicle such as a roof rack, may be taken into account in the deceleration law. Furthermore, such a method for determining a deceleration law need not be carried out under constraining test conditions, such as those usually required when determining road load.

According to one additional feature of the invention, the discrete state of the powertrain is characterized by the engaged gearbox ratio and/or the state of closure of the unit for disconnecting the engine and gearbox and/or the state of activation of an electric machine for driving the vehicle.

The association of a deceleration law with the engaged gearbox ratio and/or with the state of closure of the unit for disconnecting the engine and gearbox and/or with the state of activation of the electric machine for driving the vehicle allows engine and gearbox friction and any drive provided by the electric machine for driving the vehicle to be more accurately accounted for in the deceleration law. A plurality of deceleration laws may thus be determined for each of the discrete states of the powertrain.

According to one additional feature of the invention, the mass of the vehicle is evaluated with a view to computing the gravitational forces being exerted on the vehicle, the evaluation of the mass being carried out:
either by adding, to the unladen mass of the vehicle, the mass of at least one of the following elements:
   the mass of the passengers, this being done by adding a predetermined passenger mass for each of the seats for which a passenger-presence sensor detects the presence of a passenger,
   the mass of fuel, this being computed by multiplying the volume of fuel remaining by the density of the fuel,
or by adding the unladen mass of the vehicle to an evaluation of the vehicle load, the latter being computed on the basis of pitch-angle information delivered by a pitch-angle sensor.

The use of information generated by presence sensors of the various seats allows the number of passengers in the vehicle to be counted and thus the mass of all of the passengers to be evaluated on the basis of a predetermined average passenger mass. A different predetermined mass may be used for the various seats. A lower predetermined mass may for example be chosen for example for seats intended for children. A more precise evaluation of the mass of the vehicle is thus possible.

According to one additional feature of the invention, the evaluation of the slope is computed on the basis of geolocation information comprising altitude information.

According to one additional feature of the invention, the evaluation of the engaged gearbox ratio is computed depending on the ratio between the speed of the vehicle and the speed of the engine, engaged gearbox ratios thus being identified for set ratios between the speed of the vehicle and the speed of the engine.

According to one additional feature of the invention, the evaluation of the engaged gearbox ratio is delivered by the vehicle.

According to one additional feature of the invention, the evaluation of the state of closure of the disconnecting unit comprises computing a deviation of the ratio between the speed of the vehicle and the speed of the engine with respect to one of the set ratios between the speed of the vehicle and the speed of the engine, the disconnecting unit being evaluated closed if the deviation of the ratio between the speed of the vehicle and the speed of the engine with respect to one of the set ratios between the speed of the vehicle and the speed of the engine is zero, and the disconnecting unit being evaluated open otherwise.

According to one additional feature of the invention, the evaluation of the state of closure of the disconnecting unit is delivered by the vehicle and in particular by a sensor of position of a clutch system.

The invention also relates to a method for assisting with energy-efficient driving, comprising the following steps:
a step of determining a future route, and in particular determining a future route by means of a navigation system,
a step of retrieving a future first speed profile corresponding to the future route,
a step of recovering a future altitude profile corresponding to the future route,
a step of detecting a point on the future route at which the speed will be minimum,
a step of estimating a discrete state of the vehicle before the point on the future route at which the speed will be minimum,
a step of selecting a deceleration law evaluated using a method such as described above for the discrete state of the vehicle,
a step of computing a second speed profile depending on the deceleration law for the future altitude profile up to the point on the future route at which the speed will be minimum,
a step of computing a place to start economical deceleration, where the first speed profile and the second speed profile intersect,
a step of providing information, to a driver, by means of an interface, on the place to start economical deceleration, with a view to encouraging him to release the accelerator pedal of the vehicle in order to achieve an energy-efficient driving style.

Determining the deceleration law described above allows the distance necessary for the vehicle to reach a desired speed, in particular zero speed, to be evaluated without using the vehicle's braking system. It is thus possible to avoid wasting energy in the braking system and therefore to reduce the consumption of the vehicle. In addition, since the deceleration law determined by the method is representative of the actual driving conditions, the distance necessary for the vehicle to reach the desired speed is accurately evaluated. There is thus no need for the driver to re-accelerate or to brake.

According to one additional feature of the invention, the method for assisting with energy-efficient driving comprises, if the driver does not release the accelerator pedal of the vehicle once he reaches the place to start economical deceleration:
a step of computing a theoretical speed of arrival at the point on the future route at which the speed would be minimum if the driver were to release the accelerator pedal,
a step of providing additional information to the driver on the theoretical speed of arrival at the point on the future route at which the speed will be minimum,

the step of computing the theoretical speed of arrival and the step of providing additional information being repeated at a predetermined frequency until the driver releases the accelerator pedal.

These two steps allow information to be provided to the driver, so that he may evaluate the braking that will be necessary to reach, at the planned speed, the point on the future route at which the speed will be minimum. Such information may help the driver improve passenger comfort while maintaining an energy-efficient driving style. Specifically, during the coastdown of the vehicle, the drop in speed is very slow when the speed of the vehicle is low. It may then be desirable to limit the duration of this phase of very slow drop in speed by braking the vehicle using the braking system. Since the loss of energy in the braking system is low if the speed of the vehicle is low, the energy saving remains good while passenger comfort is improved.

According to one additional feature of the invention, the step of providing information to the driver is carried out between 5 seconds before the arrival at the place to start economical deceleration and arrival at the place to start economical deceleration.

Informing the driver slightly before arrival instead of at the place to start economical deceleration allows the driver to get ready to initiate deceleration by releasing the accelerator pedal.

According to one additional feature of the invention, the time between the step of providing information to the driver and the arrival at the place to start economical deceleration is adjustable.

This feature allows this time to be adjusted as desired by and/or depending on the reaction capacities of the driver.

The invention will possibly be better understood on reading the following description of non-limiting examples of implementation thereof and on examining the appended drawing, in which:

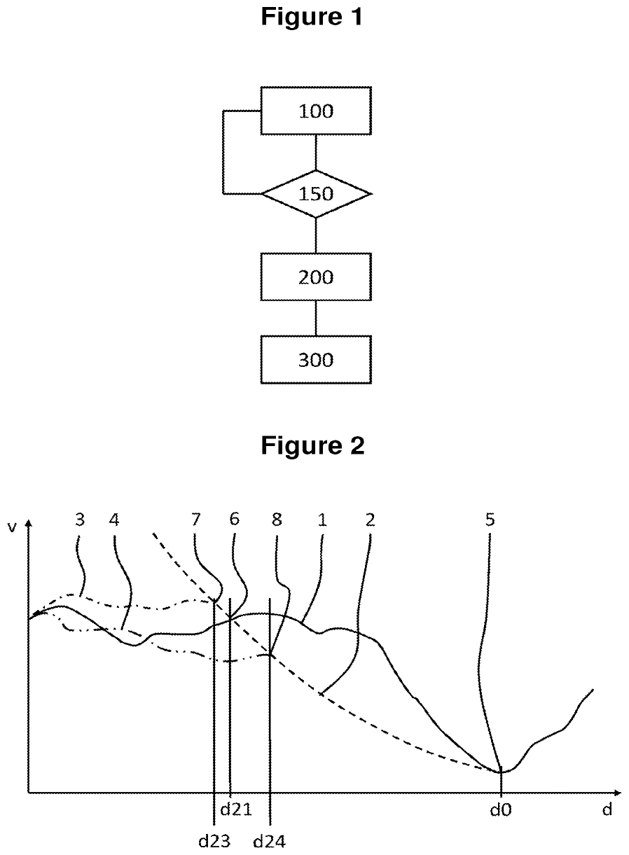

FIG. 1 shows a chart illustrating the steps of the method for determining a deceleration law according to the invention,

FIG. 2 shows the variation in the speed of a vehicle on application of the deceleration law determined with the method of FIG. 1 in a driving assistance method.

In all of the figures, elements that are identical or perform the same function have been designated with the same reference numbers. The following embodiments are examples. Although the description refers to one or more embodiments, this does not necessarily mean that each reference relates to the same embodiment, or that the features apply only to one single embodiment. Individual features of various embodiments may also be combined or interchanged in order to create other embodiments.

FIG. 1 shows, in the form of a chart, the steps of a method for determining a deceleration law of a vehicle.

The vehicle comprises an accelerator pedal, a brake pedal and a powertrain.

In the context of the present invention, the accelerator pedal is a means that allows a driver of the vehicle to control how the vehicle is driven by the powertrain. The accelerator pedal is for example a pedal actuated by the driver of the vehicle with his foot. The accelerator pedal may also be a control means actuated by the driver with his hand, or any other control means such as an acoustic control means.

In the context of the present invention, the brake pedal is a means that allows the driver of the vehicle to control a device for forcibly slowing the vehicle. The brake pedal is for example a pedal actuated by the driver of the vehicle with his foot. The brake pedal may also be a control means actuated by the driver with his hand, or any other control means such as an acoustic control means.

The powertrain comprises an engine, a gearbox and a unit for disconnecting the engine and gearbox.

The engine is for example a gasoline internal-combustion engine.

The gearbox is for example a manual gearbox and the unit for disconnecting the engine and gearbox is for example a clutch. In another example, the gearbox is an automatic gearbox and the disconnecting unit comprises a clutch and/or a torque converter.

The powertrain may also comprise an electric machine for driving the vehicle. The electric machine for driving the vehicle is for example connected to an output shaft of the engine, for example by a belt or by a chain or by a gear train. The driving electric machine may for example operate in motor mode or in generator mode. In motor mode, it drives the vehicle. In generator mode, it generates electrical power, for example from the driving power of the engine or from the kinetic energy of the vehicle during braking of the vehicle.

The deceleration law is defined for a discrete state of the powertrain. The discrete state of the powertrain is for example characterized by the engaged gearbox ratio and/or the state of closure of the disconnecting unit and/or the state of activation of the electric machine for driving the vehicle.

The engaged gearbox ratio has an influence on the friction in the gearbox and the friction in the engine.

For example when the engaged gearbox ratio is high, the engine rotates at a higher speed of rotation than when the engaged gearbox ratio is low. The higher the speed of rotation, the higher the friction in the motor. The deceleration law is therefore different for different engaged gearbox ratios.

The state of closure of the disconnecting unit is also an important parameter having an influence on the deceleration law. If the disconnecting unit is closed, engine friction has an influence on the deceleration law. An open disconnecting unit may reduce or even eliminate the effect of engine friction on the coastdown of the vehicle. The deceleration law is therefore different for a closed disconnecting unit and for an open disconnecting unit.

The state of activation of the driving electric machine also has an influence on the coastdown of the vehicle.

The method for evaluating the deceleration law comprises a first step 100 of evaluating driving parameters, comprising:
measuring the speed v of the vehicle,
evaluating the engaged gearbox ratio,
evaluating the state of closure of the disconnecting unit,
detecting the position of the accelerator pedal,
detecting the position of the brake pedal,
evaluating the slope a of the road on which the vehicle is traveling,
evaluating the mass m of the vehicle.

The measurement of the speed v of the vehicle is for example delivered by the vehicle, for example on the basis of data delivered by a sensor measuring the speed of rotation of an output shaft of the gearbox or on the basis of data delivered by a sensor measuring the speed of rotation of a wheel of the vehicle. The measurement of the speed v may also be computed from geolocation data delivered, for example, by a navigation system of the vehicle or by a mobile computer terminal equipped with a geolocation device.

The evaluation of the engaged gearbox ratio is for example computed depending on the ratio between the speed of the vehicle and the speed of the engine. Engaged gearbox ratios are identified for set ratios between the speed of the vehicle and the speed of the engine.

Depending on the type of disconnecting unit used, a tolerance in the set ratios may be applied to determine the engaged gear ratio. The application of such a tolerance may for example be used if the disconnecting unit is a torque converter comprising a lock-up clutch operating with slip.

The evaluation of the engaged gearbox ratio may also be delivered by the vehicle. For example, if the gearbox is a manual gearbox, a sensor in the gearbox may deliver the evaluation as to the engaged gearbox ratio. In another example in which the gearbox is an automatic gearbox, the evaluation of the engaged gearbox ratio is delivered by an automatic-gearbox control unit.

The evaluation of the state of closure of the disconnecting unit comprises computing a deviation of the ratio between the speed of the vehicle and the speed of the engine with respect to one of the set ratios between the speed of the vehicle and the speed of the engine. The disconnecting unit is evaluated closed if the deviation of the ratio between the speed of the vehicle and the speed of the engine with respect to one of the set ratios between the speed of the vehicle and the speed of the engine is zero. Otherwise, the disconnecting unit is evaluated open.

If the disconnecting unit is a disconnecting unit operating with slip, and in particular a torque converter comprising a lock-up clutch operating with slip, a tolerance, for example of 5%, may be applied to the set ratio to account for the slip.

The evaluation of the state of closure of the disconnecting unit is delivered by the vehicle. For example if the gearbox is a manual gearbox, the evaluation of the state of closure of the disconnecting unit may be delivered by a position sensor of a clutch system. In another example, in which the gearbox is an automatic gearbox, the evaluation of the state of closure of the disconnecting unit may be delivered by the control unit of the automatic gearbox.

The position of the accelerator pedal is for example delivered by the vehicle. The position of the accelerator pedal is for example detected by virtue of a sensor of the vehicle, in particular a potentiometer mechanically connected to the accelerator pedal.

The position of the brake pedal is for example detected by the vehicle. A switch mechanically connected to the brake pedal for example allows the actuation of the brake pedal by the driver to be detected.

The evaluation of the slope of the road on which the vehicle is traveling is for example computed on the basis of geolocation information comprising altitude information. This information is for example delivered by the vehicle's navigation system or by a mobile computer terminal equipped with a geolocation device.

The mass of the vehicle is evaluated with a view to computing the gravitational forces being exerted on the vehicle.

The mass is for example evaluated by adding the mass of the vehicle empty to the mass of at least one of the following elements:
the mass of the passengers, this being done by adding a predetermined passenger mass for each of the seats for which a passenger-presence sensor detects the presence of a passenger,
the mass of fuel, this being computed by multiplying the volume of fuel remaining by the density of the fuel.

The mass may also be evaluated by adding the unladen mass of the vehicle to an evaluation of the vehicle load, the latter being computed on the basis of pitch-angle information delivered by a pitch-angle sensor. The pitch-angle sensor is for example the pitch-angle sensor used to automatically adjust the height of the front lights of the vehicle.

In a verifying step 150, it is verified whether the accelerator pedal is in a released position and whether the brake pedal is also in a released position.

If the accelerator pedal is not in a released position and/or the brake pedal is not in a released position, the evaluation of the driving parameters continues and the second step is not performed.

If the accelerator pedal is in a released position and if the brake pedal is also in a released position, a second step 200 comprising recording the speed v of the vehicle and the slope a of the road is carried out.

Recording the speed v and the slope a comprises recording successive values of the speed v and of the slope a. A predetermined period of time separates the times at which the successive values of the speed v and of the slope a are recorded. The period of time is for example comprised between 1 ms and 1 s, and preferably between 0.1 s and 0.5 s.

The recording is for example stored on a memory of the vehicle. In another example, the recording is stored on a memory of a mobile computer terminal. In another example, the recording is stored on a remote server.

If the accelerator pedal leaves the released position and/or the brake pedal leaves the released position, the second step is exited and a third step is carried out.

A recording period corresponds to the time for which the successive values of the speed v and of the slope a are recorded. The recording period begins at the start of the second step and ends at the end of the second step.

The third step comprises computing a first coefficient f0′, a second coefficient f1′ and a third coefficient f2′ of the deceleration law representing the forces F(v) being exerted on the vehicle, with the exception of the gravitational forces being exerted on the vehicle, according to the equation:

F(v)=f0′+f1′*v+f2′*v²,

the first coefficient f0′, the second coefficient f1′ and the third coefficient f2′ depending on the mass and being computed on the basis of the recording of the speed v and of the slope a via a second-order polynomial reduction, according to the equation:

d(v)/dt=f0′(m)+f1′(m)*v+f2′(m)*v²+sin(a)

All or some of the steps may be carried out simultaneously or successively.

In one example, the first step is carried out during the second step so as to evaluate driving parameters that may be used to decide whether to interrupt the second step. For example the second step may be interrupted if the accelerator pedal is no longer in a released position and/or the brake pedal is no longer in a released position.

In one exemplary embodiment, the first coefficient f0′, the second coefficient f1′ and the third coefficient f2′ of the deceleration law may be computed, in the third step, on the basis of the values of speed v and of the values of slope a recorded during a plurality of separate recording periods, but for a given discrete state.

The method for determining the deceleration law is implemented by a computer system.

A plurality of deceleration laws corresponding to a plurality of discrete states may be recorded by the computer system.

The recording of the deceleration laws may be kept by the computer system when the vehicle is switched off, to be reused after the vehicle has been restarted.

The method allows deceleration laws to be updated to account for changes in actual driving conditions.

The determined deceleration law may be used in a method for assisting with economical driving. The aim of such a method is to give an instruction to the driver to encourage him to release the accelerator pedal at a place d21 to start economical deceleration, on a route, before a point d0 at which the speed will be minimum. By following this instruction, the driver may save energy, in particular by limiting the energy lost in the vehicle's braking system.

By point on the future route at which the speed will be minimum, what is meant is a point before which the speed will be higher and after which the speed will either be higher or remain constant for a non-zero time, for example for more than one second.

This method for assisting with economical driving is illustrated in FIG. 2, which shows the determination of the place d21 to start economical deceleration, where the driver will be encouraged to release the accelerator pedal, with a curve of variation in the speed of the vehicle on the route, and with the previously computed deceleration law. The x-axis represents the distance d on the route. The y-axis represents the speed v of the vehicle.

The method for assisting with energy-efficient driving comprises a step of determining a future route, and in particular of determining a future route by means of a navigation system. In this step, the navigation system determines the route to a destination, a destination chosen by the driver for example.

The method for assisting with energy-efficient driving further comprises a step of retrieving a future first speed profile 1 corresponding to the future route, and a step of retrieving a future altitude profile corresponding to the future route.

The method for assisting with energy-efficient driving further comprises a step of detecting the point d0 on the future route at which the speed will be minimum.

The method for assisting with energy-efficient driving further comprises a step of estimating a discrete state of the vehicle before the point d0 on the future route at which the speed will be minimum. During this step, the engaged gearbox ratio and/or the state of closure of the unit for disconnecting the engine and gearbox and/or the state of activation of the electric machine for driving the vehicle are estimated.

The method for assisting with energy-efficient driving further comprises a step of selecting the deceleration law evaluated for the discrete state of the vehicle.

The method for assisting with energy-efficient driving further comprises a step of computing a second speed profile 2 depending on the deceleration law selected beforehand for the future altitude profile up to the point d0 on the future route at which the speed will be minimum.

The following step is a step of computing the place d21 to start economical deceleration. The place d21 to start economical deceleration corresponds to the place where the first speed profile 1 and the second speed profile 2 intersect. In FIG. 2, the point where the first speed profile 1 and the second speed profile 2 intersect has been designated by the reference 6.

The method for assisting with energy-efficient driving then comprises a step of providing information, to a driver, by means of an interface, on the place d21 to start economical deceleration, with a view to encouraging him to release the accelerator pedal of the vehicle in order to achieve an energy-efficient driving style.

If the driver does not release the accelerator pedal of the vehicle once the place d21 to start economical deceleration has been reached, the method for assisting with energy-efficient driving may further comprise:
a step of computing a theoretical speed of arrival at the point on the future route at which the speed would be minimum if the driver were to release the accelerator pedal,
a step of providing additional information to the driver on the theoretical speed of arrival at the point on the future route at which the speed will be minimum.

The step of computing the theoretical speed of arrival and the step of providing additional information are repeated at a predetermined frequency until the driver releases the accelerator pedal.

The predetermined frequency is for example comprised between 2 Hz and 0.2 Hz.

The step of providing further information to the driver as regards the theoretical speed of arrival at the point on the future route at which the speed will be minimum may for example comprise displaying this theoretical speed and/or a graphic display representing the decrease in the energy savings that remain achievable.

The step of providing information to the driver may be carried out between 5 seconds before the arrival at the place d21 to start economical deceleration and arrival at the place d21 to start economical deceleration.

Under real driving conditions, a real speed profile may deviate from the first speed profile corresponding to the future route determined for example by the navigation system. To respond to this situation, the place to start economical deceleration is adapted to the real speed profile. The step of computing the place to start economical deceleration is repeated using the real speed profile as the first speed profile. The place to start economical deceleration is reached when the real speed profile and the second speed profile intersect.

In FIG. 2, two examples of real speed profiles have been shown.

A first real speed profile 3 is on the whole faster than the first speed profile corresponding to the future route determined for example by the navigation system. The first real speed profile 3 intersects the second speed profile 2 at a first place d23 to start economical deceleration. In FIG. 2, the point where the first real speed profile 3 and the second speed profile 2 intersect has been designated by the reference 7.

A second real speed profile 4 is on the whole slower than the first speed profile corresponding to the future route determined for example by the navigation system. The second real speed profile 4 intersects the second speed profile 2 at a second place d24 to start economical deceleration. In FIG. 2, the point where the second real speed profile 4 and the second speed profile 2 intersect has been designated by the reference 8.

To inform the driver of the place to start economical deceleration a time before the place of deceleration, for example between 5 seconds before the arrival at the place to start economical deceleration and the arrival at the place to start economical deceleration, it is necessary to make in advance a real-speed-profile forecast for a near future, for example less than 5 seconds in the future. The method for assisting with energy-efficient driving may therefore comprise an additional step of computing a real-speed-profile forecast.

The step of computing the place to start economical deceleration is carried out using the real-speed-profile forecast as the first speed profile. The place to start economical deceleration is reached when the real-speed-profile forecast and the second speed profile intersect.

The method for assisting with energy-efficient driving is implemented by the computer system.

In one example, the computer system is integrated into the vehicle.

In another example, the computer system is external to the vehicle. The computer system may in particular be a mobile computer terminal. The driving parameters delivered by the vehicle are then transmitted to the computer system, for example via a wired or wireless link to an internal network of the vehicle. The wired or wireless connection may in particular be made by means of an interface plugged into a diagnostic socket of the vehicle.

1. A method for evaluating the deceleration law of a vehicle comprising an accelerator pedal, a brake pedal, and a powertrain comprising an engine, a gearbox and a unit for disconnecting the engine and gearbox, the deceleration law being defined for a discrete state of the powertrain, the method for evaluating the deceleration law comprising:
a first step of evaluating driving parameters, comprising:
measuring the speed (v) of the vehicle,
evaluating the engaged gearbox ratio,
evaluating the state of closure of the disconnecting unit,
detecting the position of the accelerator pedal,
detecting the position of the brake pedal,
evaluating the slope (a) of the road on which the vehicle is traveling,
evaluating the mass (m) of the vehicle,
if the accelerator pedal is in a released position and if the brake pedal is in a released position, a second step comprising recording the speed (v) of the vehicle and the slope (a) of the road,
a third step of computing a first coefficient (f0′), a second coefficient (f1′) and a third coefficient (f2′) of the deceleration law representing the forces F(v) being exerted on the vehicle, with the exception of the gravitational forces being exerted on the vehicle, according to the equation:
F(v)=f0′+f1′*v+f2′*v²
the first coefficient f0′, the second coefficient f1′ and the third coefficient f2′ depending on the mass m and being computed on the basis of the recording of the speed v and of the slope a via a second-order polynomial reduction, according to the equation:
d(v)/dt=f0′(m)+f1′(m)*v+f2′(m)*v²+sin(a)
the method being implemented by a computer system.

2. The method for evaluating the deceleration law of a vehicle as claimed in claim 1, wherein the discrete state of the powertrain is characterized by the engaged gearbox ratio and/or the state of closure of the unit for disconnecting the engine and gearbox and/or the state of activation of an electric machine for driving the vehicle.

3. The method for evaluating the deceleration law of a vehicle as claimed in claim 1, wherein the mass of the vehicle is evaluated with a view to computing the gravitational forces being exerted on the vehicle, the mass being evaluated:
either by adding to the unladen mass of the vehicle the mass of at least one of the following elements:
the mass of the passengers, this being done by adding a predetermined passenger mass for each of the seats for which a passenger-presence sensor detects the presence of a passenger,
the mass of fuel, this being computed by multiplying the volume of fuel remaining by the density of the fuel,
or by adding the unladen mass of the vehicle to an evaluation of the vehicle load, the latter being computed on the basis of pitch-angle information delivered by a pitch-angle sensor.

4. The method for evaluating the deceleration law of a vehicle as claimed in claim 1, wherein the evaluation of the slope is computed on the basis of geolocation information comprising altitude information.

5. The method for evaluating the deceleration law of a vehicle as claimed in claim 1, wherein the evaluation of the engaged gearbox ratio is computed depending on the ratio between the speed of the vehicle and the speed of the engine, engaged gearbox ratios thus being identified for set ratios between the speed of the vehicle and the speed of the engine.

6. The method for evaluating the deceleration law of a vehicle as claimed in claim 1, wherein the evaluation of the engaged gearbox ratio is delivered by the vehicle.

7. The method for evaluating the deceleration law of a vehicle as claimed in claim 5, wherein the evaluation of the state of closure of the disconnecting unit comprises computing a deviation of the ratio between the speed of the vehicle and the speed of the engine with respect to one of the set ratios between the speed of the vehicle and the speed of the engine, the disconnecting unit being evaluated closed if the deviation of the ratio between the speed of the vehicle and the speed of the engine with respect to one of the set ratios between the speed of the vehicle and the speed of the engine is zero, and the disconnecting unit being evaluated open otherwise.

8. The method for evaluating the deceleration law of a vehicle as claimed in claim 5, wherein the evaluation of the state of closure of the disconnecting unit is delivered by the vehicle and in particular by a sensor of position of a clutch system.

9. A method for assisting with energy-efficient driving, comprising the following steps:
a step of determining a future route, and in particular determining a future route by means of a navigation system,
a step of retrieving a future first speed profile corresponding to the future route,
a step of recovering a future altitude profile corresponding to the future route,
a step of detecting a point (d0) on the future route at which the speed will be minimum,
a step of estimating a discrete state of the vehicle before the point (d0) on the future route at which the speed will be minimum,
a step of selecting a deceleration law evaluated using a method as claimed in claim 1 for the discrete state of the vehicle,
a step of computing a second speed profile depending on the deceleration law for the future altitude profile up to the point (d0) on the future route at which the speed will be minimum,
a step of computing a place (d21) to start economical deceleration, where the first speed profile and the second speed profile intersect,
a step of providing information, to a driver, by means of an interface, on the place (d21) to start economical deceleration, with a view to encouraging him to release the accelerator pedal of the vehicle in order to achieve an energy-efficient driving style.

10. The method for assisting with energy-efficient driving as claimed in claim 9 comprising, if the driver does not release the accelerator pedal of the vehicle once he reaches the place (d21) to start economical deceleration:
a step of computing a theoretical speed of arrival at the point on the future route at which the speed would be minimum if the driver were to release the accelerator pedal,
a step of providing additional information to the driver on the theoretical speed of arrival at the point on the future route at which the speed will be minimum,
the step of computing the theoretical speed of arrival and the step of providing additional information being repeated at a predetermined frequency until the driver releases the accelerator pedal.

11. The method for assisting with energy-efficient driving as claimed in claim 9, wherein the step of providing information to the driver is carried out between 5 seconds before the arrival at the place (d21) to start economical deceleration and arrival at the place (d21) to start economical deceleration.

12. The method for evaluating the deceleration law of a vehicle as claimed in claim 2, wherein the mass of the vehicle is evaluated with a view to computing the gravitational forces being exerted on the vehicle, the mass being evaluated:
either by adding to the unladen mass of the vehicle the mass of at least one of the following elements:
the mass of the passengers, this being done by adding a predetermined passenger mass for each of the seats for which a passenger-presence sensor detects the presence of a passenger,
the mass of fuel, this being computed by multiplying the volume of fuel remaining by the density of the fuel,
or by adding the unladen mass of the vehicle to an evaluation of the vehicle load, the latter being computed on the basis of pitch-angle information delivered by a pitch-angle sensor.

13. The method for evaluating the deceleration law of a vehicle as claimed in claim 2, wherein the evaluation of the slope is computed on the basis of geolocation information comprising altitude information.

14. The method for evaluating the deceleration law of a vehicle as claimed in claim 2, wherein the evaluation of the engaged gearbox ratio is computed depending on the ratio between the speed of the vehicle and the speed of the engine, engaged gearbox ratios thus being identified for set ratios between the speed of the vehicle and the speed of the engine.

15. The method for evaluating the deceleration law of a vehicle as claimed in claim 2, wherein the evaluation of the engaged gearbox ratio is delivered by the vehicle.

16. The method for evaluating the deceleration law of a vehicle as claimed in claim 6, wherein the evaluation of the state of closure of the disconnecting unit comprises computing a deviation of the ratio between the speed of the vehicle and the speed of the engine with respect to one of the set ratios between the speed of the vehicle and the speed of the engine, the disconnecting unit being evaluated closed if the deviation of the ratio between the speed of the vehicle and the speed of the engine with respect to one of the set ratios between the speed of the vehicle and the speed of the engine is zero, and the disconnecting unit being evaluated open otherwise.

17. The method for evaluating the deceleration law of a vehicle as claimed in claim 6, wherein the evaluation of the state of closure of the disconnecting unit is delivered by the vehicle and in particular by a sensor of position of a clutch system.

18. A method for assisting with energy-efficient driving, comprising the following steps:
a step of determining a future route, and in particular determining a future route by means of a navigation system,
a step of retrieving a future first speed profile corresponding to the future route,
a step of recovering a future altitude profile corresponding to the future route,
a step of detecting a point (d0) on the future route at which the speed will be minimum,
a step of estimating a discrete state of the vehicle before the point (d0) on the future route at which the speed will be minimum,
a step of selecting a deceleration law evaluated using a method as claimed in claim 2 for the discrete state of the vehicle,
a step of computing a second speed profile depending on the deceleration law for the future altitude profile up to the point (d0) on the future route at which the speed will be minimum,
a step of computing a place (d21) to start economical deceleration, where the first speed profile and the second speed profile intersect,
a step of providing information, to a driver, by means of an interface, on the place (d21) to start economical deceleration, with a view to encouraging him to release the accelerator pedal of the vehicle in order to achieve an energy-efficient driving style.

19. The method for assisting with energy-efficient driving as claimed in claim 10, wherein the step of providing information to the driver is carried out between 5 seconds before the arrival at the place (d21) to start economical deceleration and arrival at the place (d21) to start economical deceleration.

20. The method for evaluating the deceleration law of a vehicle as claimed in claim 3, wherein the evaluation of the slope is computed on the basis of geolocation information comprising altitude information.
